(19) United States
(12) Patent Application Publication
(10) Pub. No.: US 2024/0290064 A1
(43) Pub. Date: Aug. 29, 2024

(54) AUGMENTED REALITY VERIFICATION OF DATA ASSOCIATED WITH AN OBJECT

(71) Applicant: Capital One Services, LLC, McLean, VA (US)

(72) Inventors: Sze T. WONG, Allen, TX (US); Landon M. NEHMER, McKinney, TX (US); Aka NNAJI, Carrollton, TX (US); Osinaka DESMOND, Houston, TX (US); Michael GARNER, Carrollton, TX (US); Russell DANNA, Rockwall, TX (US)

(21) Appl. No.: 18/175,741

(22) Filed: Feb. 28, 2023

(51) Int. Cl. G06V 10/44; G06F 16/54; G06V 10/764

(52) U.S. Cl. CPC G06V 10/44; G06F 16/54; G06V 10/764; G06V 2201/08

(57) ABSTRACT

In some implementations, a system may receive, from an augmented reality (AR) device, a set of images captured during an AR session. The system may detect a plurality of features included in the set of images. The system may identify an item, from a list of items, that corresponds to the object based on at least one feature of the plurality of features. The list of items may identify one or more characteristics that are expected to correspond to the plurality of features. The system may identify one or more noncorresponding characteristics of the item based on determining that the one or more characteristics do not correspond to the plurality of features. The system may determine a noncorresponding value associated with the one or more noncorresponding characteristics and may provide an indication of the noncorresponding value associated with the one or more noncorresponding characteristics.

### BACKGROUND

Data storage, such as a database, a table, and/or a linked list, is an organized collection of data. A relational database is a collection of schemas, tables, queries, reports, and/or views, among other examples. Data storage designers typically organize the data storage to model aspects of reality in a way that supports processes requiring information. A data storage management system is a software application that interacts with users, other applications, and data storage to allow definition, creation, querying, update, and/or administration of data storage.

### SUMMARY

In some implementations, a system for verifying item-specific data based on data captured by an augmented reality device includes one or more memories; and one or more processors, communicatively coupled to the one or more memories, configured to: obtain item-specific data that indicates an expected value associated with an item in a list of items; receive a set of images captured by the augmented reality device, wherein the set of images are of an object; detect a set of features included in the set of images, wherein the set of features includes different features of the object; determine, based on at least one detected feature of the set of features, that the object corresponds to the item in the list of items; select one or more detected features, of the set of features, based on the expected value associated with the item; determine, based on the one or more detected features, an actual value associated with the object; determine whether the actual value associated with the object satisfies a value condition that is based on a difference between the expected value associated with the item and the actual value associated with the object; and provide an indication of whether the actual value associated with the object satisfies the value condition.

In some implementations, a method of verifying item-specific data based on data captured by an augmented reality device includes receiving, by a system and from the augmented reality device, a set of images captured during an augmented reality session of the augmented reality device; detecting, by the system, a plurality of features included in the set of images, wherein the plurality of features includes different features of an object; identifying, by the system, an item, from a list of items, that corresponds to the object based on at least one feature of the plurality of features, wherein the list of items identifies one or more characteristics that are expected to correspond to the plurality of features; determining, by the system, whether the one or more characteristics correspond to the plurality of features; identifying, by the system, one or more noncorresponding characteristics of the item based on determining that the one or more characteristics do not correspond to the plurality of features; determining, by the system, a noncorresponding value associated with the one or more noncorresponding characteristics; and providing, by the system, an indication of the noncorresponding value associated with the one or more noncorresponding characteristics.

In some implementations, a non-transitory computer-readable medium storing a set of instructions includes one or more instructions that, when executed by one or more processors of an augmented reality device, cause the augmented reality device to: capture a set of images during an augmented reality session; determine a plurality of features included in the set of images, wherein the plurality of features includes different features of an object including an identifier feature, one or more standard features, and one or more nonstandard features; decode the identifier feature to identify an item, from a list of items, that corresponds to the object, wherein the item is associated with one or more nonstandard characteristics that are expected to correspond to the one or more nonstandard features; determine whether the one or more nonstandard characteristics correspond to the one or more nonstandard features; identify the one or more nonstandard characteristics that do not correspond to the one or more nonstandard features based on determining whether the one or more nonstandard characteristics correspond to the one or more nonstandard features; and provide an indication of the one or more nonstandard characteristics that do not correspond to the one or more nonstandard features based on identifying the one or more nonstandard characteristics that do not correspond to the one or more nonstandard features.

### BRIEF DESCRIPTION OF THE DRAWINGS

FIGS. 1A-1I are diagrams of an example associated with augmented reality verification of data associated with an object, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with augmented reality verification of data associated with an object, in accordance with some embodiments of the present disclosure.

FIG. 4 is a flowchart of an example process associated with augmented reality verification of data associated with an object, in accordance with some embodiments of the present disclosure.

FIG. 5 is a flowchart of another example process associated with augmented reality verification of data associated with an object, in accordance with some embodiments of the present disclosure.

### DETAILED DESCRIPTION

The following detailed description of example implementations refers to the accompanying drawings. The same reference numbers in different drawings may identify the same or similar elements.

Often, an interaction party, such as a purchaser, a merchant, and/or a lender, may base a decision associated with an interaction on data. For example, if the interaction is associated with a used vehicle sale, interaction parties may base decisions associated with the interaction on data that indicates a current value of the used vehicle. As an example, the data that indicates the current value of the vehicle may be evaluated by a purchaser to determine how much to pay for the used vehicle, by an automotive merchant to determine how much to offer the vehicle for sale, and/or by a lender to determine whether to provide financing related to the used vehicle sale. However, if data that indicates the current value of the vehicle is inaccurate, inconsistent, unreliable, and/or incomplete, then the indicated current value of the used vehicle may be inaccurate and/or unreliable. In other words, the current value of the used vehicle based on the inaccurate, inconsistent, unreliable, and/or incomplete data may be different than an actual value of the used vehicle. This may negatively affect interaction parties associated with the interaction, such as by causing the purchaser to determine an inflated purchase price, by causing the automotive merchant to determine a deflated selling price, and/or by causing the lender to determine to finance the used vehicle sale at an inflated lending amount.

In some cases, a data analysis system may analyze data that indicates the current value of the vehicle to determine whether the data is accurate, consistent, reliable, and/or complete. For example, the data analysis system may perform optical character recognition (OCR) on an image of a valuation document that includes the data that indicates the current value of the vehicle, such as by detecting and extracting text from the valuation document. The data analysis system may use machine learning text-analysis techniques to analyze the text of the valuation document to determine whether the data is accurate, consistent, reliable and/or complete. In some cases, the data analysis system may use parsing and/or keyword extraction to compare the parsed text and/or extracted keywords to other sources of data that indicates the current value of the vehicle. For example, service providers, that may or may not be directly associated with used vehicle sales, may collect vehicle valuation data from various sources and provide the vehicle valuation sources to interaction parties. In some cases, the data analysis system may compare the parsed text and/or extracted keywords from the valuation document to the vehicle valuation data and/or other vehicle valuation information, such as information provided in a vehicle history report. The vehicle valuation data and/or the vehicle history report may indicate details associated with the current value of the vehicle, such as vehicle ownership history, accident history, odometer readings, title status, past registration as a fleet vehicle, and/or manufacturer or lemon law buybacks. However, in some cases, the vehicle valuation data and/or information in the vehicle history report may be inaccurate, inconsistent, unreliable and/or incomplete.

As an example, the vehicle valuation data and/or information in the vehicle history report may be based only on information that is supplied to a vehicle history provider, meaning that certain information (including potential problems) that are not reported to the vehicle history provider will not be included in the vehicle valuation data and/or the vehicle history report. For example, a vehicle could be involved in a major collision, rebuilt, and sold before a database used by the vehicle history provider is updated to include notice of the collision or the subsequent repairs. In another example, certain repairs may have been carried out by an independent mechanic that did not report the repairs and/or reported the repairs only to a source inaccessible to the vehicle history provider. In some cases, because the records contained in the vehicle valuation data and/or the vehicle history report are based only on events that are reported to a vehicle history provider, the vehicle history report will not include information relating to the mechanical condition of the vehicle, whether certain parts are worn, and/or whether the vehicle model includes certain components prone to early failure. Furthermore, because vehicle history databases associated with the vehicle valuation data and/or the vehicle history report typically include information from a wide range of reporting sources, such as insurance companies, motor vehicle agencies, collision repair facilities, service and/or maintenance facilities, state inspection stations, manufacturers, and/or law enforcement agencies, the vehicle valuation data and/or the vehicle history report may include mistakes, inconsistencies, and/or otherwise inaccurate data. Accordingly, in some cases, the data analysis system cannot determine whether the data that indicates the current value of the vehicle is accurate and/or reliable. This wastes resources, such as processing resources, network resources, and/or memory resources, by performing data verification operations, via the data analysis system, based on inaccurate, inconsistent, unreliable, and/or incomplete data such that the results of the data verification operations are inaccurate and/or unreliable. This may also lead to wasting resources to remedy issues caused by interaction parties relying on the inaccurate and/or unreliable data when making decisions associated with vehicle, such as a used vehicle sale. As an example, the purchaser of the used vehicle may use resources to change and/or update data in a public database associated with the used vehicle, the automotive merchant may use resources to change and/or update data in an internal database, and/or the lender may use resources to communicate with the purchaser and/or the automotive merchant to indicate a discrepancy between the current value indicated by the data and the actual value of the vehicle, to request verification of data associated with the used vehicle, and/or to request a refund based on an inflated lending amount.

Some implementations described herein provide an augmented reality (AR) device and an image processing system that facilitate verifying data based on an AR session. The AR device may capture a set of images, such as by using a camera of the AR device, associated with an object, such as a product, during an AR session and may determine one or more features of the object. The AR device may provide the set of images to the image processing system, which may determine that the object corresponds to an item, in a list of items, that is associated with an expected value. For example, the image processing system may determine that the object corresponds to the item based on determining that the one or more features of the object correspond to one or more characteristics associated with the item.

The image processing system may select features associated with the object, based on the expected value of the item, to determine an actual value of the object. For example, features associated with the object may have an associated value, and one feature, or a combination of features, may have a value that is equal to (or greater than) the expected value associated with the item and/or that meets a threshold based on the expected value. The image processing system may determine whether the actual value associated with the object corresponds to the expected value of the item. For example, the image processing system may determine whether the actual value of the object corresponds to the expected value of the item based on a difference between the actual value of the object and the expected value of the item. The image processing system may provide an indication of whether the actual value associated with the object corresponds to the expected value of the item.

In this way, the image processing system may provide an interaction party associated with the object and/or the item, such as the user of the AR device, a purchaser, a merchant, and/or a lender, with a verified indication of whether the actual value of the object, such as an actual value of a used vehicle being viewed in the AR session, corresponds to the expected value of the item, such as an expected value indicated by data associated with a used vehicle that corresponds to the used vehicle being viewed in the AR session. As a result, some implementations described herein conserve resources that would otherwise have been used to perform data verification operations based on inaccurate, inconsistent, unreliable, and/or incomplete data such that the results of the data verification operations are inaccurate and/or unreliable. Furthermore, some implementations described herein conserve resources that would otherwise be used to remedy issues caused by the inaccurate and/or unreliable data associated with the current value of the vehicle.

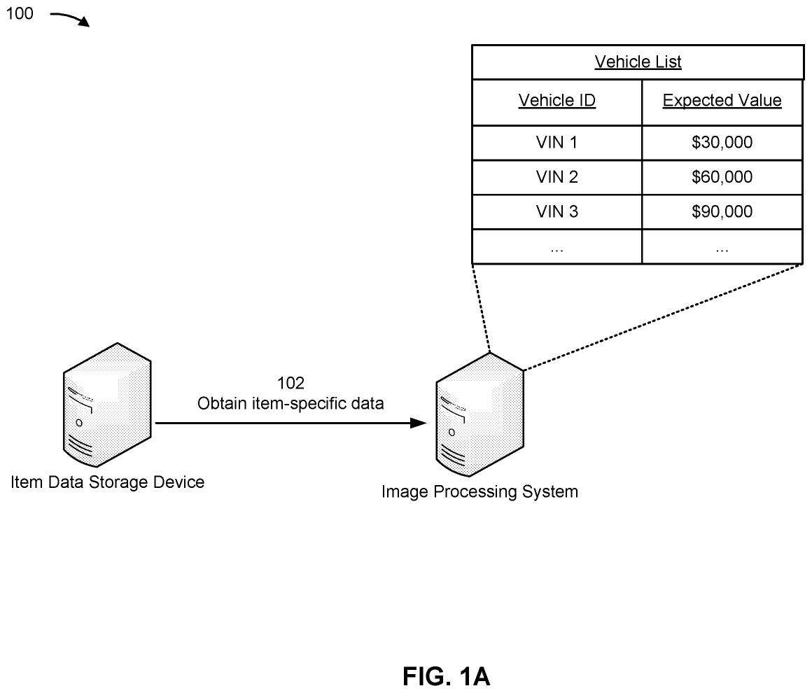

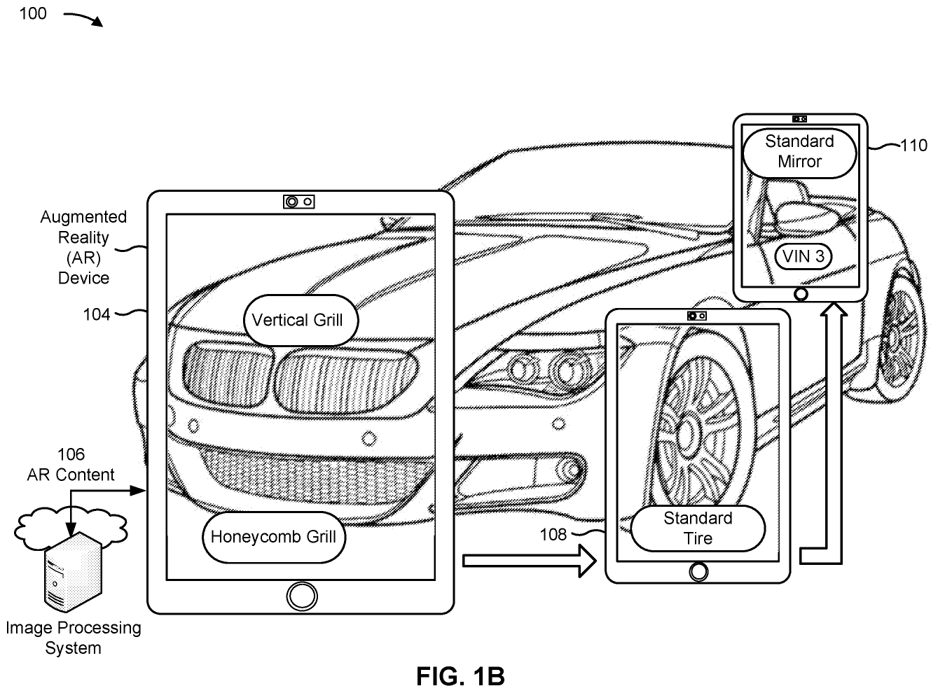

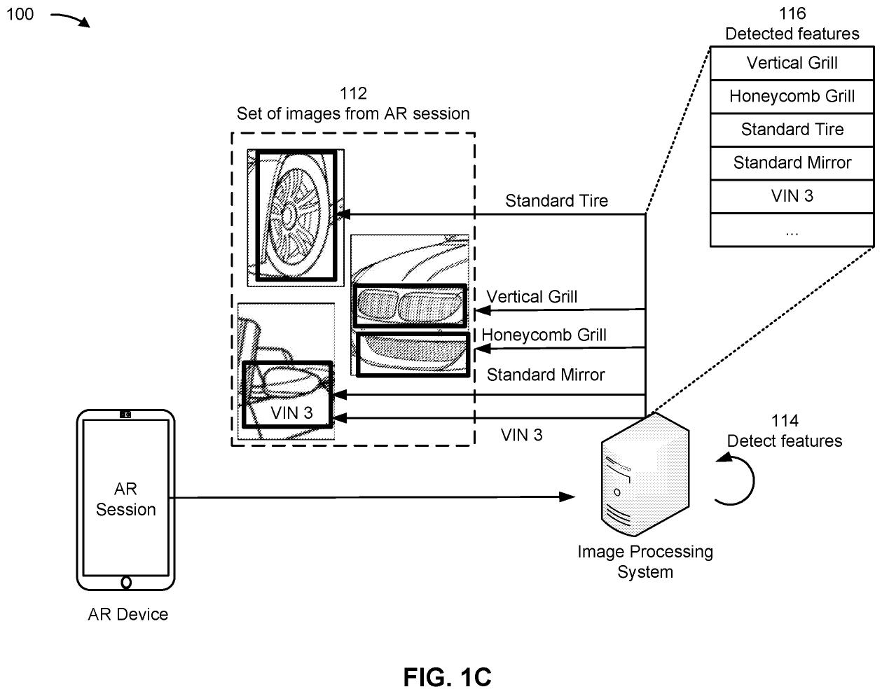

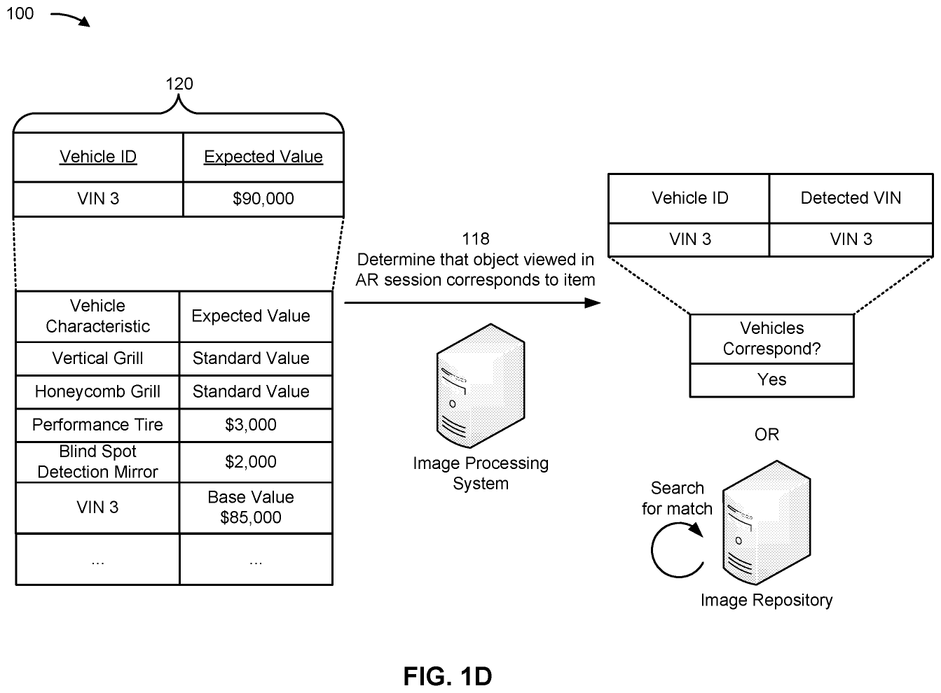

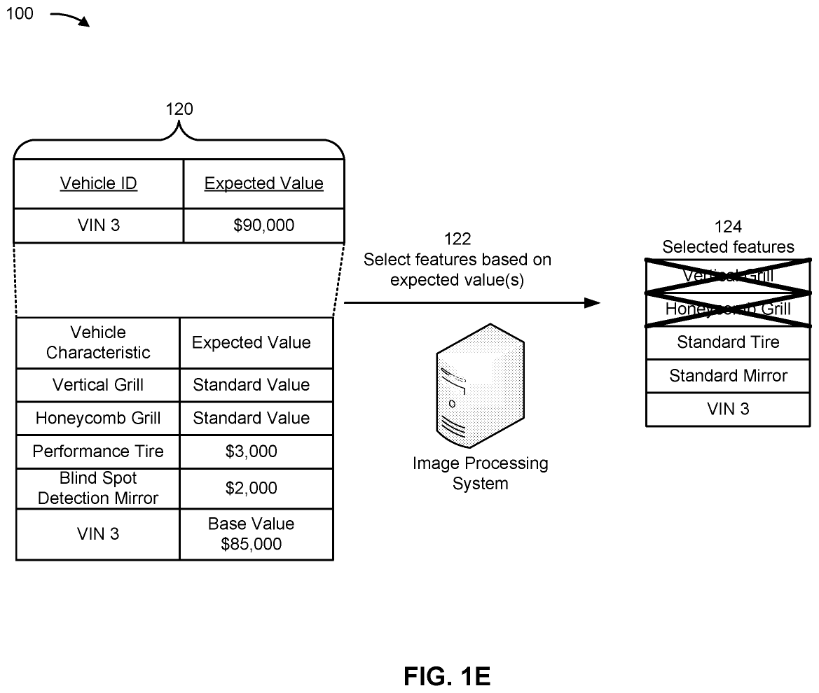

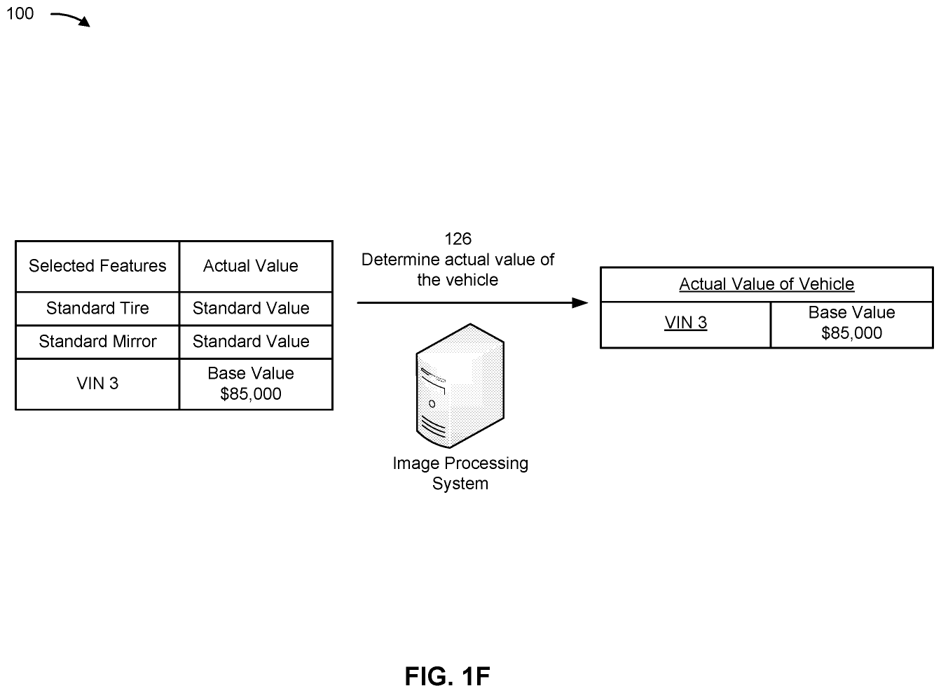

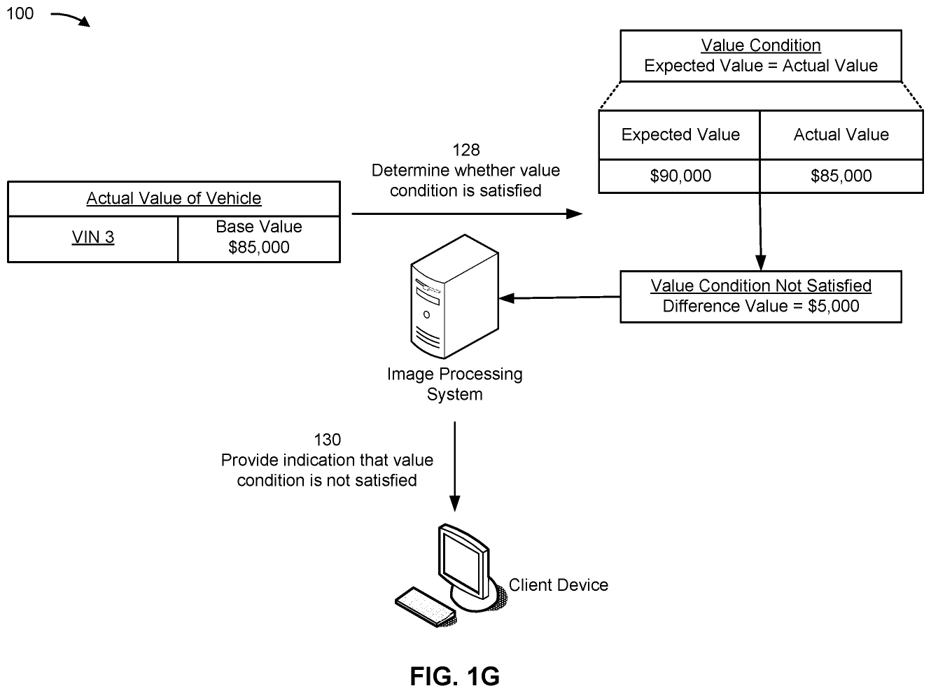

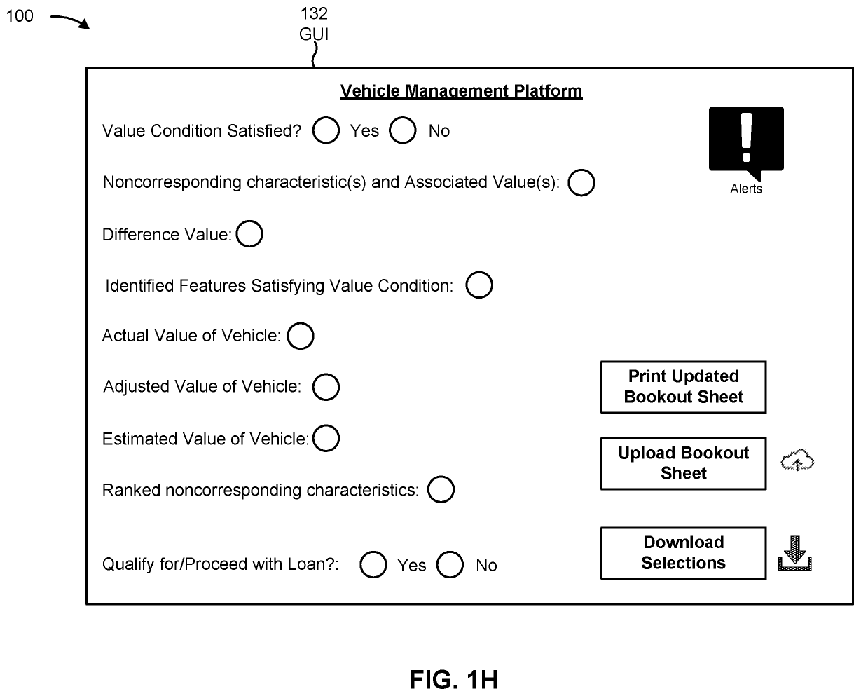

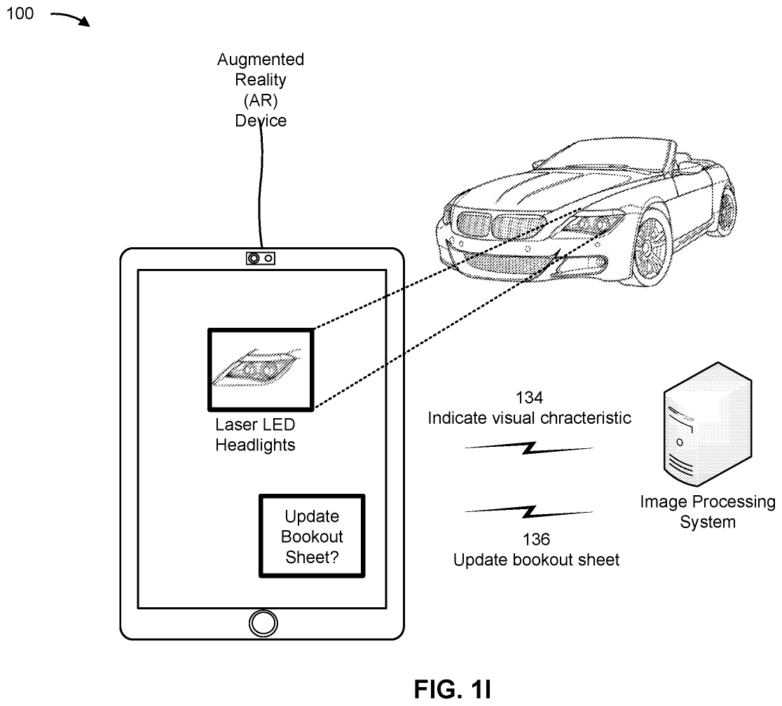

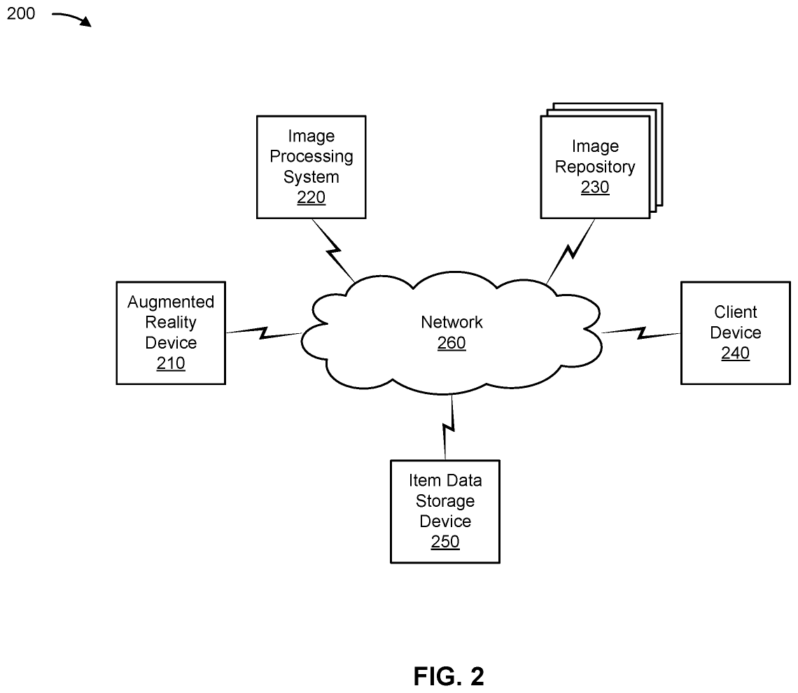

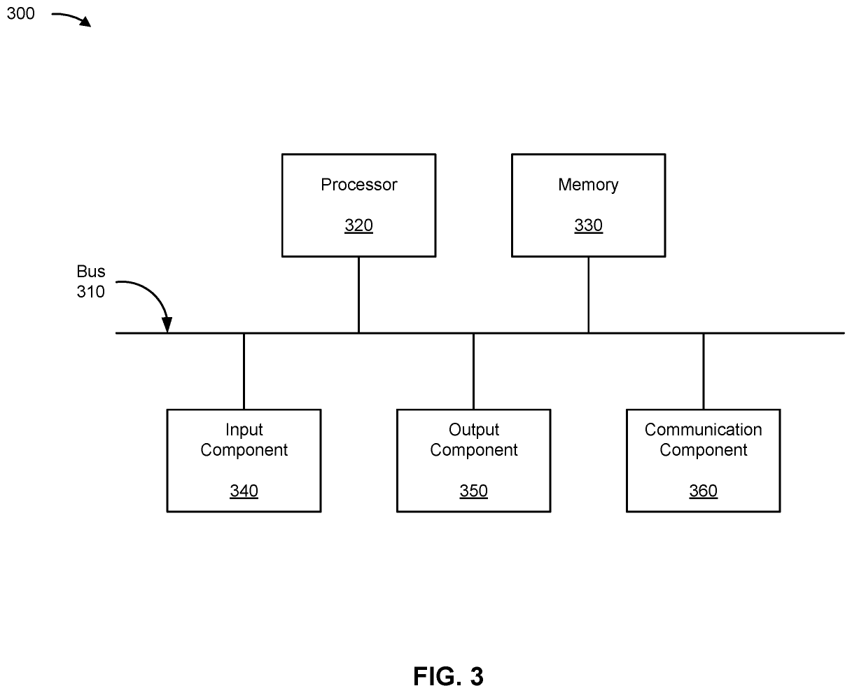

FIGS. 1A-1I are diagrams of an example 100 associated with augmented reality verification of data associated with an object. As shown in FIGS. 1A-1I, example 100 includes an image processing system, an augmented reality (AR) device, an item data storage device, an image repository, a client device, and/or a network. These devices are described in more detail in connection with FIGS. 2 and 3.

As shown in FIG. 1A, and by reference number 102, the image processing system may obtain item-specific data associated with an item (e.g., one or more items). For example, the item data storage device may transmit, and the image processing system may obtain, the item-specific data associated with the item via a network. In some implementations, the item data storage device may be associated with an entity, such as an automotive merchant and/or a service provider that collects and provides vehicle valuation data to other interaction parties, such as automotive merchants, automotive manufacturers, financial institutions, insurance companies, and/or governmental agencies, among other examples. Additionally, or alternatively, the image processing system may obtain the item-specific data from another data source, such as a user device associated with an entity and/or an application executed by a client device associated with an entity, as described in more detail elsewhere herein.

In some implementations, the item-specific data associated with the item may indicate an identifier that identifies the item, a characteristic (e.g., one or more characteristics) associated with the item, an expected value associated with the characteristic (e.g., each characteristic), and/or an expected value associated with the item. As an example, the characteristic associated with the item may indicate specific information associated with the item that affects a value of, or associated with, the item, such as a feature, a quality, a current state, and/or a geographical location associated with the item, among other examples. Thus, in some implementations, the value of the item may be based on the characteristic associated with the item. In some implementations, the expected value associated with the characteristic may indicate a value associated with the characteristic, and the expected value associated with the item may indicate a value associated with the item. In some implementations, the expected value associated with the characteristic and/or the expected value associated with the item may be based on a point in time, such as a current time. As an example, the current time may be a time at which the item is offered for sale.

In some implementations, the item-specific data may be vehicle-specific data associated with a vehicle. For example, the vehicle-specific data may indicate a vehicle identifier that identifies the vehicle, a characteristic (e.g., one or more vehicle characteristics) associated with the vehicle, an expected value associated with the characteristic (e.g., each characteristic), and/or an expected value associated with the vehicle. As an example, the vehicle identifier may be a vehicle identification number (VIN) that corresponds to the vehicle and enables identification of the vehicle. The VIN may be a 17-character number that encodes specific information associated with the vehicle, such as a manufacturer, a vehicle type, a model year, a make, a model, a body class, a trim, a drive type, safety features, standard features, available optional features. In some implementations, the VIN may be decoded to extract the specific information associated with the vehicle, as described in more detail elsewhere herein. As another example, the vehicle identifier may be a unique characteristic of the vehicle that has one or more features that enable the vehicle to be identified, such as a grill characteristic in combination with a side mirror characteristic that have unique features that can be identified via a search, as described in more detail elsewhere herein.

In some implementations, the characteristic associated with the vehicle may indicate specific information associated with the vehicle that affects a value associated with the vehicle. As an example, the specific information associated with the vehicle may include information encoded by the VIN (described above) and/or information associated with optional features, nonstandard features, dealer-added features, modifications, a current state, a geographical location, auction information, and/or historical information associated with the vehicle.

In some implementations, the expected value associated with the characteristic may indicate a value associated with the characteristic, and the expected value associated with the vehicle may indicate a value associated with the vehicle, at a point in time, such as at a current time. In some implementations, the expected value associated with the characteristic and/or the expected value associated with the vehicle may be indicated in a bookout sheet, which is a document that includes bookout data that indicates an expected value associated with the characteristic and/or the vehicle.

For example, the bookout data may indicate specific information associated with the vehicle's value, at a point in time, such as standard characteristics and/or non-standard characteristics associated with the vehicle, values associated with the standard characteristics and/or the nonstandard characteristics, and/or a value of the vehicle, at the current time. In some implementations, an interaction party that is directly associated with an interaction, such as an automotive merchant performing a new vehicle and/or a used vehicle sale, may generate the bookout sheet that indicates the expected value associated with the vehicle.

As an example, the automotive merchant may generate the bookout sheet to indicate the expected value associated with the characteristics and/or the expected value associated with the vehicle before selling a new vehicle and/or before selling a used vehicle. The bookout sheet may be provided to a lender, such as a financial institution, and the lender may determine whether to finance the sale based on the expected value associated with the characteristics and/or the expected value associated with the vehicle being offered for sale. In other implementations, an interaction party that is not directly associated with an interaction, such as a third-party bookout sheet provider, may generate the bookout sheet and may provide the bookout sheet to the automotive merchant, the potential purchaser, and/or the lender.

In some implementations, bookout data associated with multiple bookout sheets (corresponding to multiple vehicles) may be stored in the item data storage device, such as in a data structure. Thus, in some implementations, the bookout data may indicate a list of vehicles and information associated with the vehicles, such as the expected value associated with characteristics of the vehicles and/or the expected value of the vehicles in the list of vehicles. As shown in FIG. 1A, for example, the bookout data is associated with multiple vehicles and indicates a vehicle identifier for each vehicle (shown as VIN 1, VIN 2, and VIN 3). The bookout data further indicates an expected value associated with each of the vehicles (shown as $30,000 for VIN 1, $60,000 for VIN 2, and $90,000 for VIN 3).

As shown in FIG. 1B, a user of the AR device may use the AR device to view an object in an AR session that overlays information on an image of the object, or a portion of the object captured by the AR device, such as by using a camera. For example, the AR device may overlay (e.g., superimpose) information on a physical object being viewed and/or on media presented for display via the user interface. Thus, in some implementations, the AR device may overlay information on media that is captured by the AR device and/or that is associated with the AR device. As an example, the AR device may overlay information on media including three-dimensional (3D) models, two-dimensional (2D) models, information associated with a webpage (e.g., text and/or links to another webpage), text (e.g., from documents), images, and/or videos. Thus, in some implementations, the AR device may overlay information on the media that is captured by the AR device in the AR session and/or media that is otherwise obtained by the AR device.

The object may be a vehicle, such as a car (as shown in FIG. 1B), a motorcycle, a boat, or a plane. Alternatively, the item may be a consumer product, such as furniture, artwork, a television, a computer, or a mobile telephone. In general, the item may be any physical item that includes characteristics that affect a value associated with the item. In some implementations, the user may interact with a user interface of the AR device to cause the AR device to execute an AR application for the AR session.

In some implementations, the AR device, such as when providing an AR session, may capture a set of images associated with the object. For example, as shown in FIG. 1B, the AR device may obtain a set of images associated with a car. Each image, of the set of images, may include one or more features of the object. In some implementations, each image, of the set of images captured by the AR device, includes multiple features of the object. A feature of the object may include any visual element of the object that can be viewed and/or captured in an image. For example, as shown by reference number 104, an image of the car may include an upper grill (identified in the AR session as a vertical grill) and a lower grill (identified in the AR session as a honeycomb grill) captured from the front of the car. A feature of the object may be associated with a visual characteristic, such as a shape, a texture, a color, a color pattern, a curvature, a physical size, a luminosity, and/or a design.

In some implementations, the AR device may process an image to detect, determine, and/or identify one or more features of the object (e.g., one or more distinguishing features, customizable features, configurable features of the object, that would be relevant to collecting item-specific data). For example, with regard to reference number 104, the AR device may process an image using a computer vision technique, such as an object detection technique and/or an object recognition technique, to identify the upper grill and the lower grill. In an additional example, the AR device may determine that the upper grill is a vertical grill (e.g., the upper grill has a vertical configuration or design) and that the lower grill is a honeycomb grill (e.g., the lower grill has a honeycomb configuration or design). Although in some implementations the AR device may process an image to identify features, in some other implementations the image processing system may receive an image or image data from the AR device, process the image to detect features, and transmit, to the AR device, information that identifies the detected features.

Based on the detected features, the AR device may determine AR content, which may include information, such as text or graphics, to be overlaid on an image captured by the AR device and displayed on a user interface of the AR device. Alternatively, as shown by reference number 106, the AR device may receive AR content determined by the image processing system (e.g., based on one or more images transmitted from the AR device to the image processing system and/or one or more features included in the one or more images). In some implementations, the AR device and/or the image processing system may identify the AR content by performing a visual search, using an image as a search query, to identify the feature and/or a visual characteristic of the feature based on the image (e.g., using a data structure and/or a machine learning algorithm).

When providing the AR session, the AR device may present the AR content on an image (e.g., overlaid on a captured image) based on one or more identified features included in the image. For example, as shown by reference number 104, the AR device may present an image of the car (or a portion of the car) on the user interface of the AR device, and may overlay AR content on the image. In example implementation 100, the AR content includes a first AR overlay object that labels the upper grill of the car as a vertical grill and a second AR overlay object that labels the lower grill of the car as a honeycomb grill.

In some implementations, an AR overlay object may include a feedback object (e.g., one or more feedback objects). A user may interact with an AR feedback object, via the user interface of the AR device, to provide user input indicative of user feedback (e.g., confirmation or a nonconfirmation that a feature is present, confirmation or a nonconfirmation that a feature is properly working, approval or disapproval, desire or lack of desire, and/or preference or dislike) about a visual characteristic of a feature associated with the AR overlay object. For example, the user may interact with an AR feedback object of an AR overlay object (e.g., by selecting a confirmation button) to indicate confirmation that a visual characteristic corresponds to a visual characteristic associated with one or more features of the object. The AR device may store the user feedback as feedback data, such as in a data structure (e.g., a database, an electronic file structure, and/or an electronic file) of the AR device. Additionally, or alternatively, the AR device may transmit the feedback data to another device for storage, such as the profile storage device described elsewhere herein.

As shown by reference number 108, in a second example, the AR device may obtain a second set of images associated with a tire of the car (e.g., during the same AR session as described above in connection with the first example). The image of the car may include a tire (identified in the AR session as a standard tire) captured from the front driver side of the car. The AR device may process the image using the object detection technique to identify the tire as a standard tire. In other words, the standard tire is a standard feature associated with the vehicle and is not an optional and/or an added feature associated with the vehicle. Further, in example implementation 100, the AR content includes an AR overlay object that labels the tire as a standard tire.

As shown by reference number 110, in a third example, the AR device may obtain a third set of images associated with a side mirror of the car and a VIN of the car (e.g., during the same AR session as described above in connection with the first example). The image of the car may include a side mirror (identified in the AR session as a standard side mirror) and a VIN (identified in the AR session as VIN 3) captured from the driver side of the car. The AR device may process the image using the object detection technique to identify the side mirror as a standard mirror and the VIN. In other words, the standard side mirror is a standard feature associated with the vehicle and is not an optional and/or an added feature associated with the vehicle. Further, in example implementation 100, the AR content includes an AR overlay object that labels the side mirror as a standard mirror and an AR overlay object that labels the VIN as VIN 3. In some implementations, the AR device may decode the VIN to determine specific information associated with the vehicle, as described in more detail elsewhere herein.

As shown in FIG. 1C, and by reference number 112, the AR device may send a set of images, captured during an AR session, to the image processing system. In some implementations, the AR device may send a full set of images, such as the images that were captured by the AR device during the AR session (e.g., as described above in connection with FIG. 1B). As shown by reference number 114, the image processing system may process the set of images to detect one or more features of the object, in a similar manner as described above in connection with FIG. 1B. As shown by reference number 116, the image processing system detects the features identified as the vertical grill, the honeycomb grill, the standard tire, the standard mirror, and the VIN 3.

As shown in FIG. 1D, and by reference number 118, the image processing system may determine that the object viewed in the AR session corresponds to an item, from a list of items. In some implementations, the image processing system may determine that the vehicle viewed in the AR session corresponds to a vehicle, in a list of vehicles, based on a detected feature associated with the vehicle being viewed in the AR session and a characteristic associated with the vehicle in the list of vehicles. As an example, the image processing system may query the list of vehicles based on the VIN detected in the AR session. The image processing system may identify the vehicle, in the list of vehicles, based on detected VIN in the query. As shown in FIG. 1D, the image processing system may determine that the vehicle viewed in the AR session corresponds to a vehicle, in the list of vehicles, based on the detected VIN matching a VIN from the vehicle in the list of vehicles (e.g., VIN 3).

Alternatively, the image processing system may determine that the vehicle viewed in the AR session corresponds to a vehicle, in a list of vehicles, based on performing a search. In some implementations, the image processing system may determine one or more visual characteristics that correspond to at least one detected feature of the vehicle being viewed in the AR session. The image processing system may perform a search using an image repository and based on the one or more visual characteristics to identify one or more aspects associated with a vehicle in the list of vehicles, such as by using a data structure and/or a machine learning algorithm. The image processing system may determine that the one or more aspects correspond to the at least one detected feature based on the one or more aspects including features having visual characteristics that have a threshold degree of similarity with the one or more visual characteristics that correspond to the at least one detected feature of the vehicle being viewed in the AR session. The image processing system may determine that the object corresponds to the item based on determining that the one or more aspects correspond to the at least one detected feature.

For example, the image processing system may determine one or more visual characteristics that correspond to the vertical grill, the honeycomb grill, the standard tire, and/or the standard side mirror of the vehicle being viewed in the AR session. The image processing system may perform a search using an image repository, such as an image repository that includes images of the characteristics of the vehicles, in the list of vehicles, and based on the one or more visual characteristics that correspond to the vertical grill, the honeycomb grill, the standard tire, and/or the standard side mirror to identify one or more aspects associated with a vehicle, in the list of vehicles. For example, the one or more aspects associated with the vehicle, in the list of vehicles, having visual characteristics that have a threshold degree of similarity with the one or more visual characteristics that correspond to at least one of the vertical grill, the honeycomb grill, the standard tire, and/or the standard side mirror of the vehicle being viewed in the AR session. The image processing system may determine that the vehicle being viewed in the AR session corresponds to the vehicle, in the list of vehicles, based on determining that the one or more aspects correspond to at least one of the vertical grill, the honeycomb grill, the standard tire, and/or the standard side mirror of the vehicle being viewed in the AR session.

Based on determining that the vehicle viewed in the AR session corresponds to the vehicle in the list of vehicles (also referred to as a corresponding vehicle), the image processing system may determine the characteristics, the expected values associated with the characteristics, and/or the expected value associated with the corresponding vehicle. In some implementations, the one or more characteristics associated with the corresponding vehicle are expected to correspond to features of the vehicle being viewed in the AR session. In some implementations, the image processing system may determine whether one or more characteristics associated with the corresponding vehicle correspond to one or more of the detected features of the vehicle being viewed in the AR session. As an example, the image processing system may identify one or more noncorresponding characteristics based on determining that the one or more characteristics do not correspond to the one or more detected features. In some implementations, the image processing system may determine a value associated with the one or more noncorresponding characteristics.

In some implementations, the image processing system may determine whether the one or more noncorresponding characteristics includes at least one standard noncorresponding characteristic and/or at least one nonstandard noncorresponding characteristic. In some implementations, the at least one standard noncorresponding characteristic may be a characteristic that has a standard value, such as a value that is included in a base value associated with the corresponding vehicle, and that does not correspond to a feature of the vehicle being viewed in the AR session. For example, if the at least one standard noncorresponding characteristic is a standard audio system that has a standard value, and the vehicle being viewed in the AR session has a feature that is a high-fidelity audio system that has a value of $5,000 (e.g., the $5,000 is not included in a base value associated with the corresponding vehicle), then the image processing system may determine that the standard audio system is a standard noncorresponding characteristic associated with the corresponding vehicle. In some implementations, the at least one nonstandard noncorresponding characteristic may be a characteristic that has a nonstandard value, such as a value that is not included in a base value associated with the vehicle, and that does not correspond to a feature of the vehicle being viewed in the AR session. As another example, if the at least one nonstandard noncorresponding characteristic is a high fidelity audio system that has a nonstandard value of $5,000, and the vehicle being viewed in the AR session has a feature that is a standard audio system that has a standard value, then the image processing system may determine that the high-fidelity audio system is a nonstandard noncorresponding characteristic associated with the corresponding vehicle.

As shown by reference number 120 of FIG. 1D, for example, the image processing system determines that the characteristics associated with the corresponding vehicle (e.g., identified by the vehicle identifier VIN 3) are a vertical grill, a honeycomb grill, a performance tire, and a blind spot detection mirror. The image processing system further determines that the expected value associated with the corresponding vehicle is $90,000, that the expected value associated with the vertical grill is a standard value, that the expected value associated with the honeycomb grill is a standard value, that the expected value associated with the performance tire is $3,000, that the expected value associated with the blind spot detection mirror is $2,000, and that the expected value associated with the vehicle identified by the vehicle identifier of VIN 3 is a base value of $85,000. In other words, the base value of the vehicle identified by the vehicle identifier of VIN 3 has a base value of $85,000, nonstandard features that have a value included in the base value, and additional nonstandard features valued at $5,000. Thus, in this example, the expected value of the corresponding vehicle (e.g., identified by the vehicle identifier of VIN 3) is $90,000.

As shown in FIG. 1E, and by reference number 122, the image processing system may select one or more detected features based on the expected value associated with the characteristics and/or the expected value associated with the corresponding vehicle. For example, the image processing system may determine that the corresponding vehicle is associated with nonstandard noncorresponding characteristics and may determine nonstandard values associated with the nonstandard noncorresponding characteristics. In some implementations, the image processing system may select one or more detected features, of the set of features, detected in the AR session based on the expected value associated with the corresponding vehicle and/or the nonstandard values associated with the nonstandard noncorresponding characteristics to enable the image processing system to determine an actual value of the vehicle being viewed in the AR session, as described in more detail elsewhere herein. As shown in FIG. 1E, for example, the performance tire is a nonstandard noncorresponding characteristic that has a nonstandard value of $3,000, and the blind spot detection mirror is a nonstandard noncorresponding characteristic that has a nonstandard value of $2,000, where neither the performance tire nor the blind spot detection mirror corresponds to a feature of the vehicle being viewed in the AR session. Further, the nonstandard value of $3,000 associated with the performance tire and the nonstandard value of $2,000 associated with the blind spot detection mirror increase the base value of $85,000 associated with the corresponding vehicle to the expected value of $90,000. Thus, as shown by reference number 124, the image processing system selects the standard tire and the standard mirror as the detected features based on the expected value associated with the corresponding vehicle, the nonstandard value associated with the performance tire, and the nonstandard value associated with the blind spot detection mirror. The selected features enable the image processing system to determine the actual value of the vehicle being viewed in the AR session, as described in more detail elsewhere herein.

As shown in FIG. 1F, and by reference number 126, the image processing system may determine an actual value associated with the vehicle being viewed in the AR session. For example, the image processing system may determine the actual value of the vehicle being viewed in the AR session based on an actual value associated with the selected features. As shown in FIG. 1F, the image processing system determines that the actual value of the vehicle having a standard tire and a standard mirror rather than a performance tire and a blind spot detection mirror, respectively. In other words, the bookout data associated with the corresponding vehicle is inaccurate because the vehicle being viewed in the AR session does not have a performance tire nor a blind spot detection mirror. Thus, in some implementations, the image processing system may update the bookout data associated with the corresponding vehicle such that the bookout data indicates that the corresponding vehicle has an expected value of $85,000, a standard tire rather than a performance tire, and/or a standard side mirror rather than a blind spot detection mirror, as described in more detail elsewhere herein.

As shown in FIG. 1G, and by reference number 128, the image processing system may determine whether a value condition is satisfied. In some implementations, the value condition may be based on a difference between the expected value associated with the corresponding vehicle and the actual value associated with the vehicle being viewed in the AR session. For example, the value condition may be that the expected value is equal to (or less than) the actual value. As shown in FIG. 1G, the image processing system determines that the value condition is not satisfied because the expected value of $90,000 is greater than the actual value of $85,000. As shown by reference number 130 of FIG. 1G, the image processing system may provide an indication that the value condition is not satisfied to a client device, such as a client device associated with a financial institution. In some implementations, the financial institution may request a refund from an automotive merchant based on the value condition not being satisfied. In some implementations, the image processing system may determine a difference value based on determining that the actual value associated with the vehicle does not satisfy the value condition. In this example, the image processing system may determine that the difference value is $5,000 based on the expected value of $90,000 associated with the corresponding vehicle and the actual value of $85,000 associated with the vehicle being viewed in the AR session.

In some implementations, the value condition may be that the difference between the actual value associated with the vehicle and the expected value associated with the corresponding vehicle satisfies a threshold. In some implementations, the difference between the actual value associated with the vehicle and the expected value associated with the corresponding vehicle satisfies a threshold if the difference is greater than (or equal to) the threshold. In some implementations, the threshold may be based on a situation where the difference between the actual value associated with the vehicle and the expected value associated with the corresponding vehicle indicates that the actual value associated with the vehicle is greater than the expected value associated with the corresponding vehicle or may be based on a situation where the difference between the actual value associated with the vehicle is less than the expected value associated with the corresponding vehicle.

In some implementations, the image processing system may identify a subset of the one or more detected features that enable the value condition to be satisfied. As an example, if the threshold is $2,000 based on an expected value of a corresponding vehicle that is $90,000, and if the vehicle being viewed in the AR session has a base value of $85,000, has a nonstandard feature of a performance tire that has a nonstandard value of $3,000, and has a nonstandard feature of a blind spot detection mirror that has a nonstandard value of $2,000, then the image processing system may identify the performance tire as the subset of the one or more features, which enables the value condition to be satisfied. In other words, the base value of $85,000 of the vehicle being viewed in the AR session plus the nonstandard value of $3,000 associated with the performance tire is equal to $88,000, which satisfies the threshold (e.g., the difference between $90,000 and $88,000 is $2,000).

In this way, the image processing system may determine that the threshold is met without determining a value associated with all features of the vehicle being viewed in the AR session. In some implementations, the image processing system may provide an indication that the value condition is not satisfied only if a discrepancy between the expected value associated with the corresponding vehicle and an actual value of the vehicle being viewed in the AR session is greater than (or equal to) a threshold. In this way, a financial institution may only desire to investigate a discrepancy between the expected value associated with the corresponding vehicle and the actual value of the vehicle is greater than (or equal to) a predetermined amount.

In some implementations, the image processing system may identify one or more noncorresponding characteristics associated with the corresponding vehicle, based on determining that the one or more characteristics do not correspond to the features of the vehicle being viewed in the AR session, and may determine a noncorresponding value associated with the one or more noncorresponding characteristics. In the example implementation 100, the image processing system may identify the performance tire and the blind spot detection mirror as noncorresponding characteristics associated with the corresponding vehicle. In this example, the image processing system may determine that an itemized value of the noncorresponding performance tire is $3,000 and that the itemized value of the noncorresponding blind spot detection mirror is $2,000. In some implementations, the image processing system may associate the noncorresponding characteristics with priority levels.

As an example, the image processing system may associate the noncorresponding characteristics with priority levels based on the itemized value associated with the noncorresponding characteristics. For example, if the image processing system determines that that itemized value of the noncorresponding performance tire is $3,000 and that the itemized value of the noncorresponding blind spot detection mirror is $2,000, then the image processing system may associate the noncorresponding performance tire with a higher priority level than a priority level with the noncorresponding blind spot detection mirror. The image processing system may rank the noncorresponding characteristics, based on the associated priority levels, to generate ranked noncorresponding characteristics. In this example, the image processing system may rank the noncorresponding performance tire characteristic higher than the noncorresponding blind spot detection mirror characteristic.

In some implementations, the image processing system may determine a noncorresponding value associated with the noncorresponding characteristics based on the itemized value of the noncorresponding characteristics. For example, if the image processing system determines that that itemized value of the noncorresponding performance tire is $3,000 and that the itemized value of the noncorresponding blind spot detection mirror is $2,000, then the image processing system may determine that a noncorresponding value (e.g., a total value) associated with the noncorresponding characteristics is $5,000.

In some implementations, the expected value associated with the corresponding vehicle may be an initial value, and the image processing system may adjust the initial value associated with the corresponding vehicle based on the noncorresponding value. As an example, if the initial value is $90,000, and the noncorresponding value is $5,000, then the adjusted value is $85,000. Thus, in some implementations, the adjusted value may represent a discrepancy between the initial value of the corresponding vehicle (e.g., the expected value associated with the corresponding vehicle) and an actual value of the vehicle being viewed in the AR session. In some implementations, the image processing system may obtain location information that identifies a location of the AR device, and may adjust the initial value based on the location of the AR device. In this way, for example, the image processing system may adjust the initial value (e.g., the expected value of the corresponding vehicle) based on value adjustments associated with the location of the AR device.

In some implementations, the image processing system may determine whether the noncorresponding value associated with the noncorresponding characteristics satisfies a threshold. In some implementations, the noncorresponding value associated with the noncorresponding characteristics may satisfy the threshold if the noncorresponding value is greater than (or equal to) the threshold. As an example, if the threshold is $4,000, and if the noncorresponding value is $5,000, then the noncorresponding value satisfies the threshold. In some implementations, the image processing system may generate an alert based on determining that the noncorresponding value satisfies the threshold. In this way, for example, a financial institution may only desire to investigate the actual value of the vehicle being viewed in the AR session of the noncorresponding value is greater than (or equal to) a predetermined amount.

In some implementations, the image processing system may update the list of vehicles to generate an updated list of vehicles such that the updated list of vehicles does not include at least a portion of one or more noncorresponding characteristics. Referring to the example implementation 100, the image processing system may update the list of vehicles such that the updated list of vehicles does not include data that indicates the noncorresponding performance tire characteristics and/or the noncorresponding blind spot detection mirror characteristic associated with the noncorresponding vehicle. In some implementations, the image processing system may replace data that indicates the noncorresponding performance tire characteristic with data that indicates the corresponding standard tire characteristic and replace data that indicates the noncorresponding blind spot detection mirror characteristic with data that indicates the corresponding standard side mirror characteristic in the list of vehicles. In other words, the image processing system may update the bookout data associated with the corresponding vehicle in the list of vehicles such that the image processing system may generate an accurate bookout sheet associated with the corresponding vehicle.

In some implementations, the image processing system may determine a visual characteristic corresponding to an aspect included in at least a portion of the one or more noncorresponding characteristics associated with the corresponding vehicle. In some implementations, the AR device may provide information that identifies the visual characteristic to cause the AR device to display the information that identifies the visual characteristic for display via a user interface of the AR device. Thus, in some implementations, the image processing system may indicate the visual characteristic of a noncorresponding characteristic associated with the corresponding vehicle for display when the noncorresponding characteristic actually corresponds to a feature of the vehicle being viewed but the corresponding feature has not been viewed.

In some implementations, the image processing system may obtain user input provided via the user interface of the AR device that indicates a confirmation or a nonconfirmation that the visual characteristic corresponds to a visual characteristic associated with one or more features of vehicle being viewed in the AR session. This may allow a user of the AR device to indicate whether the vehicle being viewed includes a characteristic associated with the corresponding vehicle indicated by the list of vehicles that has not been viewed by the AR device.

In some implementations, the AR device may detect a VIN and decode the VIN during the AR session to extract specific information that indicates an identifier feature, standard features, available optional features, and/or nonstandard features associated with the vehicle being viewed. In some implementations, the AR device may identify an item, from a list of items, that corresponds to the vehicle being viewed based on the identifier feature, determine whether one or more nonstandard characteristics correspond to one or more nonstandard features associated with the vehicle being viewed, and identify the one or more nonstandard characteristics that do not correspond to the one or more nonstandard features based on determining whether the one or more nonstandard characteristics correspond to the one or more nonstandard features. The AR device may provide an indication of the one or more nonstandard characteristics that do not correspond to the one or more nonstandard features based on identifying the one or more nonstandard characteristics that do not correspond to the one or more nonstandard features.

In some implementations, the AR device may provide the indication of the one or more nonstandard features and data associated with one or more standard features of the vehicle being viewed to a device, such as the image processing system. In some implementations, the AR device may obtain, from the device, an estimated value associated with the vehicle being viewed based on the one or more standard features and the indication of the one or more nonstandard characteristics that do not correspond to the one or more nonstandard features. In some implementations, the AR device may obtain, from the device, an actual value associated with the vehicle being viewed that is based on a difference between the estimated value of the vehicle being viewed and the expected value associated with the corresponding vehicle. In some implementations, the AR device may provide, to the device, data associated with the one or more nonstandard characteristics associated with the corresponding vehicle. In some implementations, the AR device may obtain, from the device, an itemized value for at least one nonstandard characteristic of the one or more nonstandard characteristics.

As shown in FIG. 1H, and by reference number 132, the image processing system may provide a graphical user interface (GUI) for display, such as via the client device. For example, a client device associated with an entity, such as a financial institution, may execute a platform (shown as “Vehicle Management Platform”) to manage information associated with a list of vehicles, such as the list of vehicles including bookout data (described above). In some implementations, the platform may be a computer program (e.g., an application) that is executable on the client device. As an example, the platform may be in communication with the image processing system via the client device, and the platform may include the GUI that receives a user input from a user of the client device.

In some implementations, the image processing system may generate a document object model (DOM) for the GUI of the platform. For example, the image processing system may generate the DOM for the GUI of the platform in response to the client device requesting a resource associated with the platform (e.g., the GUI associated with the platform) from the image processing system. For example, if the client device executes the platform based on a user input, such as a user inputting log in credentials, then the client device may request the GUI from the image processing system. In some implementations, the GUI may be a document object, such as a page associated with the financial institution, that may be associated with managing the bookout data associated with the list of vehicles. In some implementations, the document object may include an input option (e.g., one or more selectable fields and/or one or more fillable fields) associated with inputting information associated with the vehicle, in the list of vehicles, and/or an output indicator that indicates information associated with the vehicle, in the list of vehicles. For example, the image processing system may modify the DOM associated with the GUI to cause the input option and/or the output indicator to be included in the GUI. In some implementations, the image processing system may transmit, and the client device may receive, an indication of the DOM of the GUI. For example, the image processing stem may transmit the indication of the DOM of the GUI in response to the client device requesting a resource (e.g., the GUI of the platform) from the image processing system. For example, if a user signs into the platform, such as when the client device receives authenticated user credentials for an account registered with the platform, then the client device may request the GUI from the image processing system.

In some implementations, the client device may display the GUI based on the DOM. For example, the client device may display the GUI based on receiving the indication of the

DOM of the GUI from the image processing system. In some implementations, the indication of the DOM of the GUI may include code for generating the GUI, and the client device may execute the code to display the GUI (e.g., in a page of the platform). In some implementations, the client device may present the GUI to a user of the client device. As shown in FIG. 1H, the GUI may include multiple input options and multiple output options associated with a vehicle, in the list of vehicles. The multiple input options may enable a user, via the client device, to input user selections associated with a vehicle and/or perform other operations, such as uploading vehicle information and the multiple output options may enable information associated with the vehicle, in the list of vehicles, to be indicated to the user, as described in more detail elsewhere herein.

As shown in FIG. 1H, the GUI includes input options of “Noncorresponding characteristic(s) and Associated Value(s),” “Difference Value,” “Identified Features Satisfying Value Condition,” “Actual Value of Vehicle,” Adjusted Value of Vehicle,” “Estimated Value of Vehicle,” “Ranked noncorresponding characteristics,” “Print Updated Bookout Sheet,” “Upload Bookout Sheet,” and “Download Selections.”

In some implementations, the user of the client device may select one or more of the multiple input options, and press the Download Selections button to download data associated with the selections. The Noncorresponding characteristic(s) and Associated Value(s) input option may be associated with data that indicates noncorresponding characteristics associated with a corresponding vehicle and associated values of the noncorresponding characteristics, the Difference Value input option may be associated with data that indicates a difference value associated with a corresponding vehicle, the Identified Features Satisfying Value Condition may be associated with data that indicates the subset of the detected features that enable the value condition to be satisfied, the Actual Value of Vehicle may be associated with data that indicates the actual value of the vehicle being viewed in the AR session that corresponds to the corresponding vehicle, the Adjusted Value of Vehicle may be associated with data that indicates a discrepancy between the initial value of the corresponding vehicle (e.g., the expected value associated with the corresponding vehicle) and an actual value of the vehicle being viewed in the AR session, the Estimated Value of Vehicle may be associated with data that indicates the estimated value of the vehicle being viewed in the AR session, and the Ranked noncorresponding characteristics may be associated with data that indicates the ranked noncorresponding characteristics, as described in more detail elsewhere herein.

In some implementations, the user of the client device may select the Print Updated Bookout Sheet button to print an updated bookout sheet associated with a corresponding vehicle. Additionally, or alternatively, the Print Updated Bookout Sheet may be configured such that when the user of the client device selects the Print Updated Bookout Sheet button, the GUI may present a popup window that enables the user to share the updated Bookout Sheet (e.g., via email) before printing the updated Bookout sheet. In some implementations, the user of the client device may select the Upload Bookout Sheet button to upload a bookout sheet associated with a vehicle in the list of vehicles.

As shown in FIG. 1H, the GUI includes output indicators of “Value Condition Satisfied” and “Qualify for/Proceed with Loan?” In some implementations, the image processing system may provide an indication of whether the value condition associated with a corresponding vehicle is satisfied, and may cause the platform to display a “Yes” indication based on an indication that the value condition is satisfied or display a “No” indication based on an indication that the value condition is not satisfied. In some implementations, the image processing system may determine whether a potential purchaser associated with the corresponding vehicle qualifies for a loan associated with the corresponding vehicle or whether the potential purchaser may proceed with additional steps related to the loan process. In some implementations, the image processing system may provide an indication of whether the potential purchaser qualifies for the loan or whether the potential purchaser may proceed with additional steps related to the loan process, and may cause the platform to display a “Yes” indication based on an indication that the potential purchaser qualifies for the loan or may proceed with additional steps or may cause the platform to display a “No” indication based on an indication that the potential purchase does not qualify for the loan or may not proceed with additional steps. In this way, the image processing system may enable accurate loan qualification based on verifying the actual value associated with the vehicle being viewed in the AR session before determining whether the potential purchaser qualifies for the loan.

As shown in FIG. 1I, and by reference number 134, the image processing system may indicate a visual characteristic to the AR device to cause the AR device to display the visual characteristic via the user interface. For example, the image processing system may determine a visual characteristic corresponding to an aspect included in at least a portion of the one or more noncorresponding characteristics associated with the corresponding vehicle. In some implementations, the AR device may provide information that identifies the visual characteristic to cause the AR device to display the information that identifies the visual characteristic for display via a user interface of the AR device. Thus, in some implementations, the image processing system may indicate the visual characteristic of a noncorresponding characteristic associated with the corresponding vehicle for display when the noncorresponding characteristic actually corresponds to a feature of the vehicle being viewed but the corresponding feature has not been viewed by the AR device. As shown in FIG. 1I, the image processing system provides information that identifies a visual characteristic associated with the laser light emitting diode (LED) headlights of the vehicle being viewed in the AR session. In this example, the laser LED headlights were not viewed by the AR device such that the laser LED headlights were determined to be a noncorresponding characteristic when the laser LED headlights are a corresponding characteristic. In some implementations, the AR device may cause the AR device to display the incorrectly identified noncorresponding characteristic, via an overlay and/or text presented on a display of the user interface. The user may confirm that the incorrectly identified noncorresponding characteristic is a corresponding characteristic.

As shown in FIG. 1I, the image processing system may obtain user input provided via the user interface of the AR device that indicates a confirmation or a nonconfirmation that the visual characteristic corresponds to a visual characteristic associated with one or more features of vehicle being viewed in the AR session. This may allow a user of the AR device to indicate whether the vehicle being viewed includes a characteristic associated with the corresponding vehicle indicated by the list of vehicles that has not been viewed by the AR device. As shown by reference number 136, a user may press the Update Bookout Sheet button to confirm that the vehicle includes the laser LED headlights.

Thus, in some implementations, the AR device may be used as a tool for data collection and validation, such as within the automotive domain. In some implementations, the user may provide feedback to verify bookout data associated with a vehicle, in a list of vehicles. In some implementations, the AR device may use object recognition techniques to enable potential new and used vehicle purchasers to identify features and/or accessories associated with the vehicle being viewed in the AR session. In some implementations, the AR device may determine features and/or provide a walkthrough of features associated with the vehicle being viewed in the AR session, such as during a vehicle shopping process.

In some implementations, the user may use the AR device to scan the VIN, an exterior, and/or an interior of the vehicle being viewed in the AR session, and the AR device may list the features as the views the vehicle. In some implementations, the user may provide feedback, such as by a tapping motion, that may trigger the AR device to display details of features associated with the vehicle being viewed in the AR session. This may enable a financial institution collect data associated with the vehicle being viewed before determining whether to verify bookout data before determining whether to finance a vehicle sale.

In some implementations, the user of the AR device may obtain supplemental information associated with the vehicle. In some implementations, the user may use the AR device to obtain supplemental information associated with the vehicle from one or more information sources associated with the vehicle. For example, the user may use the AR device to obtain supplemental information transmitted from the vehicle over a Controller Area Network (CAN bus) associated with the vehicle (e.g., via a wired and/or a wireless connection), to obtain supplemental information transmitted by a chip diagnostic reader associated with the vehicle, and/or to obtain supplemental information from a document (e.g., a window sticker) associated with the vehicle, such as by capturing an image of the document.

In some implementations, the user may provide supplemental information associated with the vehicle to the AR device. For example, the user may upload a file that contains supplemental information associated with the vehicle and/or may cause the AR device to be directed to a webpage containing supplemental information associated with the vehicle.

In some implementations, the AR device may be used to configure and build a vehicle based on features associated with the vehicle being viewed in the AR session (e.g., based on a year, a make, and/or a model associated with the vehicle being viewed in the AR session). As an example, this may enable the AR device and/or the image processing system to determine whether a potential purchase qualifies for a loan associated with the vehicle being viewed in the AR session.

In some implementations, the AR device and/or the image processing system may provide the user with recommendations of vehicles with similar features based on features associated with the vehicle being viewed in the AR session. In some implementations, the AR may indicate expected features associated with the vehicle being viewed that have not been scanned by the AR device for display via the user interface of the AR device, and the user of the AR device can provide feedback as to whether the vehicle being viewed includes the expected features.

In some implementations, the AR device may determine an estimated price of the vehicle being viewed based on data collected (e.g., the vehicle make, model, and/or year and/or an estimated market price). In some implementations, machine learning techniques may be used to determine an estimated vehicle price range associated with the vehicle being viewed. In some implementations, a clustering algorithm may be used to recommend vehicles with similar features and/or other vehicles that other users have viewed using an AR device. In some implementations, a machine learning algorithm may be used to predict one or more conditions associated with a vehicle being viewed that indicate a probability of that the expected value of a corresponding vehicle does not match an actual value of the vehicle being viewed.

In this way, the image processing system may provide an interaction party associated with the object and/or the item, such as the user of the AR device, a purchaser, a merchant, and/or a lender, with a verified indication of whether the actual value of the object, such as an actual value of a used vehicle being viewed in the AR session, corresponds to the expected value of the item, such as an expected value indicated by data associated with a used vehicle that corresponds to the used vehicle being viewed in the AR session. As a result, some implementations described herein conserve resources that would otherwise have been used to perform data verification operations based on inaccurate, inconsistent, unreliable, and/or incomplete data such that the results of the data verification operations are inaccurate and/or unreliable. Furthermore, some implementations described herein conserve resources that would otherwise be used to remedy issues caused by the inaccurate and/or unreliable data associated with the current value of the vehicle.

As indicated above, FIGS. 1A-1I are provided as an example. Other examples may differ from what is described with regard to FIGS. 1A-1I.

FIG. 2 is a diagram of an example environment 200 in which systems and/or methods described herein may be implemented. As shown in FIG. 2, environment 200 may include an AR device 210, an image processing system 220, an image repository 230, a client device 240, an item data storage device 250, and/or a network 260. Devices of environment 200 may interconnect via wired connections, wireless connections, or a combination of wired and wireless connections.

The AR device 210 may include one or more devices capable of receiving, generating, storing, processing, and/or providing information associated with verifying data associated with an object based on an AR session, as described elsewhere herein. The AR device 210 may include a communication device and/or a computing device. For example, the AR device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. In some implementations, the AR device may capture (e.g., record) the AR session. For example, the AR device may record the AR session and store the associated data in various data structures and/or data representations, such as 3D data representations. The associated data may be accessible and/or displayed (e.g., via the virtual reality headset) for various purposes, such as confirming bookout data indicated in a bookout sheet associated with a vehicle.

The image processing system 220 may include one or more devices capable of receiving, generating, storing, processing, providing, and/or routing information associated with verifying data associated with an object based on an AR session, as described elsewhere herein. The image processing system 220 may include a communication device and/or a computing device. For example, the image processing system 220 may include a server, such as an application server, a client server, a web server, a database server, a host server, a proxy server, a virtual server (e.g., executing on computing hardware), or a server in a cloud computing system. In some implementations, the image processing system 220 may include computing hardware used in a cloud computing environment.

The image repository 230 may include one or more devices capable of receiving, generating, storing, processing, and/or providing information associated with images of objects and/or information associated with images of objects, as described elsewhere herein. The image repository 230 may include a communication device and/or a computing device. For example, the image repository 230 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the image repository 230 may store images of vehicles and/or information associated with images of vehicles, as described elsewhere herein.

The client device 240 may include one or more devices capable of receiving, generating, storing, processing, and/or providing information associated with displaying information via the GUI for the platform, as described elsewhere herein, as described elsewhere herein. The client device 240 may include a communication device and/or a computing device. For example, the client device 240 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The item data storage device 250 may include one or more devices capable of receiving, generating, storing, processing, and/or providing information associated with items, in a list of items, as described elsewhere herein. The item data storage device 250 may include a communication device and/or a computing device. For example, the item data storage device 250 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the item data storage device 250 may store a list of vehicles.

The network 260 may include one or more wired and/or wireless networks. For example, the network 260 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 260 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with augmented reality verification of data associated with an object. The device 300 may correspond to the AR device 210, the image processing system 220, the image repository 230, the client device 240, and/or the item data storage device 250. In some implementations, the AR device 210, the image processing system 220, the image repository 230, the client device 240, and/or the item data storage device 250 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

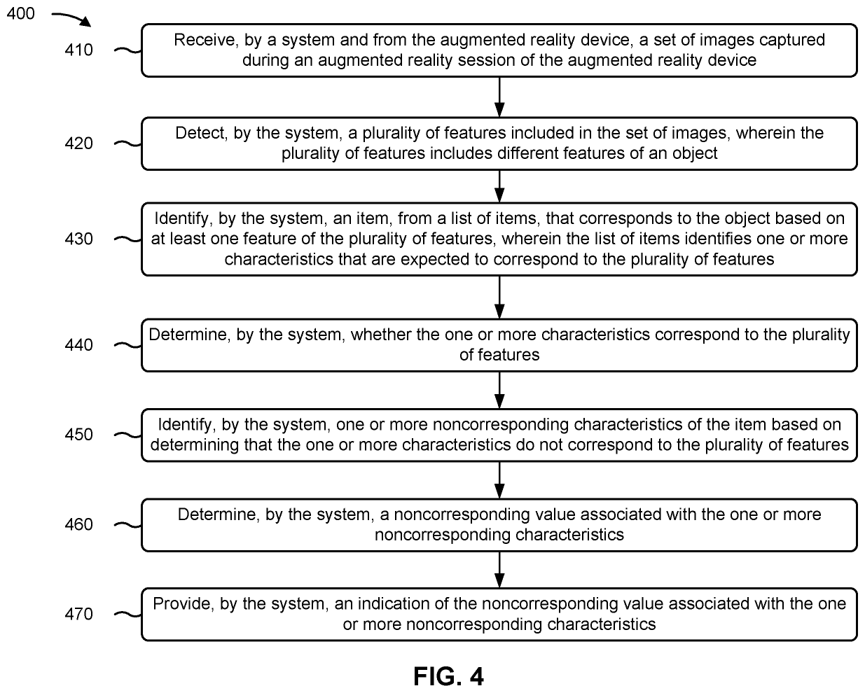

FIG. 4 is a flowchart of an example process 400 associated with augmented reality verification of data associated with an object. In some implementations, one or more process blocks of FIG. 4 may be performed by the image processing system 220. In some implementations, one or more process blocks of FIG. 4 may be performed by another device or a group of devices separate from or including the image processing system 220, such as an AR device (e.g., AR device 210), an image repository (e.g., image repository 230), a client device (e.g., client device 240), and/or an item data storage device (e.g., item data storage device 250). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving, from the augmented reality device, a set of images captured during an augmented reality session of the augmented reality device (block 410). For example, the image processing system 220 (e.g., using processor 320, memory 330, input component 340, and/or communication component 360) may receive, from the augmented reality device, a set of images captured during an augmented reality session of the augmented reality device, as described above in connection with reference number 112 of FIG. 1C. As an example, a user of the AR device may use the AR device to capture a set of images associated with a car during an AR session. The images may include one or more features of the object. The AR device may send a set of images, such as the images that were captured by the AR device during the AR session to the image processing system.

As further shown in FIG. 4, process 400 may include detecting a plurality of features included in the set of images, wherein the plurality of features includes different features of an object (block 420). For example, the image processing system 220 (e.g., using processor 320 and/or memory 330) may detect a plurality of features included in the set of images, wherein the plurality of features includes different features of an object, as described above in connection with reference number 114 of FIG. 1C. As an example, the AR device may use an object detection technique to identify a feature of the car, such as the vertical grill identified in FIG. 1B.

As further shown in FIG. 4, process 400 may include identifying an item, from a list of items, that corresponds to the object based on at least one feature of the plurality of features, wherein the list of items identifies one or more characteristics that are expected to correspond to the plurality of features (block 430). For example, the image processing system 220 (e.g., using processor 320 and/or memory 330) may identify an item, from a list of items, that corresponds to the object based on at least one feature of the plurality of features, wherein the list of items identifies one or more characteristics that are expected to correspond to the plurality of features, as described above in connection with reference number 118 of FIG. 1D. As an example, the image processing system may determine that the vehicle viewed in the AR session corresponds to a vehicle, in a list of vehicles, based on a detected feature associated with the vehicle being viewed in the AR session and a characteristic associated with the vehicle, in the list of vehicles, corresponding to one another. In some implementations, the list of items identifies one or more characteristics that are expected to correspond to the plurality of features.

As further shown in FIG. 4, process 400 may include determining whether the one or more characteristics correspond to the plurality of features (block 440). For example, the image processing system 220 (e.g., using processor 320 and/or memory 330) may determine whether the one or more characteristics correspond to the plurality of features, as described above in connection with FIG. 1D. As an example, the image processing system determine whether one or more characteristics associated with the corresponding vehicle correspond to one or more of the detected features of the vehicle being viewed in the AR session.

As further shown in FIG. 4, process 400 may include identifying one or more noncorresponding characteristics of the item based on determining that the one or more characteristics do not correspond to the plurality of features (block 450). For example, the image processing system 220 (e.g., using processor 320 and/or memory 330) may identify one or more noncorresponding characteristics of the item based on determining that the one or more characteristics do not correspond to the plurality of features, as described above in connection with FIG. 1D. As an example, the image processing system may identify one or more noncorresponding characteristics based on determining that the one or more characteristics do not correspond to the one or more detected features.

As further shown in FIG. 4, process 400 may include determining a noncorresponding value associated with the one or more noncorresponding characteristics (block 460). For example, the image processing system 220 (e.g., using processor 320 and/or memory 330) may determine a noncorresponding value associated with the one or more noncorresponding characteristics, as described above in connection with FIG. 1G. As an example, the image processing system may identify one or more noncorresponding characteristics associated with the corresponding vehicle, based on determining that the one or more characteristics do not correspond to the features of the vehicle being viewed in the AR session, and may determine a noncorresponding value associated with the one or more noncorresponding characteristics.

As further shown in FIG. 4, process 400 may include providing an indication of the noncorresponding value associated with the one or more noncorresponding characteristics (block 470). For example, the image processing system 220 (e.g., using processor 320 and/or memory 330) may provide an indication of the noncorresponding value associated with the one or more noncorresponding characteristics, as described above in connection with reference number 132 of FIG. 1H. As an example, a user of a client device may select the Noncorresponding characteristic(s) and Associated Value(s) input option to obtain the indication of the noncorresponding value associated with the one or more noncorresponding characteristics.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1I. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

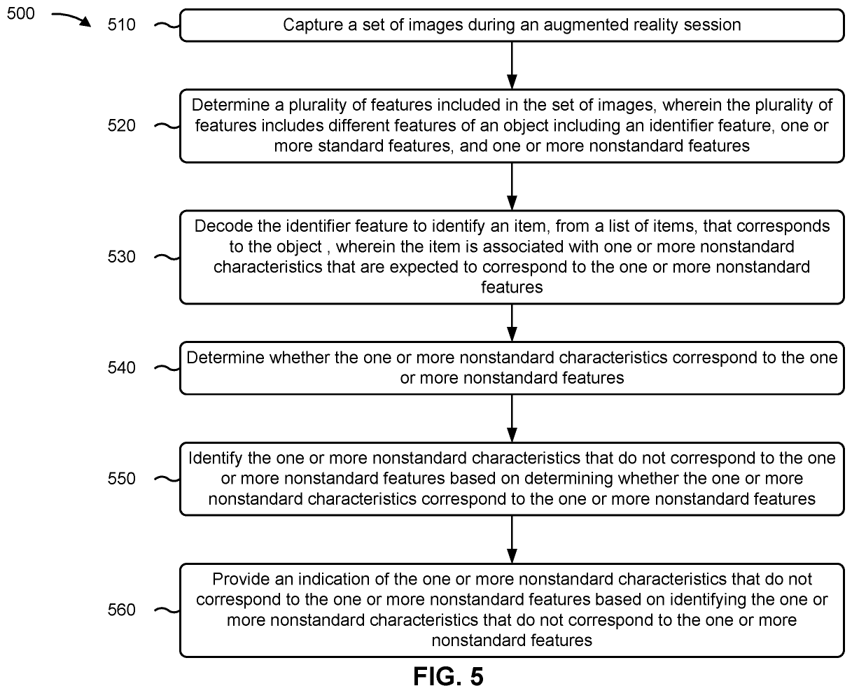

FIG. 5 is a flowchart of an example process 500 associated with augmented reality verification of data associated with an object. In some implementations, one or more process blocks of FIG. 5 may be performed by the AR device 210. In some implementations, one or more process blocks of FIG. 5 may be performed by another device or a group of devices separate from or including the AR device 210, such as the image processing system 220, the image repository 230, the client device 240, and/or the item data storage device 250. Additionally, or alternatively, one or more process blocks of FIG. 5 may be performed by one or more components of the device 300, such as processor 320, memory 330, input component 340, output component 350, and/or communication component 360.

As shown in FIG. 5, process 500 may include capturing a set of images during an augmented reality session (block 510). For example, the AR device 210 (e.g., using processor 320 and/or memory 330) may capture a set of images during an augmented reality session, as described above in connection with reference numbers 104, 108, and 110 in FIG. 1B. As an example, the AR device may capture a set of images associated with the object (e.g., shown as a car in FIG. 1B) during an AR session.

As further shown in FIG. 5, process 500 may include determining a plurality of features included in the set of images, wherein the plurality of features includes different features of an object including an identifier feature, one or more standard features, and one or more nonstandard features (block 520). For example, the AR device 210 (e.g., using processor 320 and/or memory 330) may determine a plurality of features included in the set of images, wherein the plurality of features includes different features of an object including an identifier feature, one or more standard features, and one or more nonstandard features, as described above in connection with reference number 114 in FIG. 1C. As an example, the AR device may use an object detection technique to identify an identifier feature (shown as VIN 3 in FIG. 1C), a standard feature of the car (e.g., shown as standard tire in FIG. 1C), and/or a nonstandard feature of the car if the car includes a nonstandard feature (e.g., the car in FIG. 1C does not include a nonstandard feature).

As further shown in FIG. 5, process 500 may include decoding the identifier feature to identify an item, from a list of items, that corresponds to the object, wherein the item is associated with one or more nonstandard characteristics that are expected to correspond to the one or more nonstandard features (block 530). For example, the AR device 210 (e.g., using processor 320 and/or memory 330) may decode the identifier feature to identify an item, from a list of items, that corresponds to the object, wherein the item is associated with one or more nonstandard characteristics that are expected to correspond to the one or more nonstandard features, as described above in connection with FIG. 1B.

As an example, the AR device may detect a VIN and decode the VIN during the AR session to extract specific information that indicates an identifier feature, standard features, available optional features, and/or nonstandard features associated with the vehicle being viewed. In some implementations, the item is associated with one or more nonstandard characteristics that are expected to correspond to the one or more nonstandard features.

As further shown in FIG. 5, process 500 may include determining whether the one or more nonstandard characteristics correspond to the one or more nonstandard features (block 540). For example, the AR device 210 (e.g., using processor 320 and/or memory 330) may determine whether the one or more nonstandard characteristics correspond to the one or more nonstandard features, as described above in connection with FIG. 1E. As an example, the AR device may determine whether the performance tire nonstandard characteristic corresponds to a nonstandard feature of the vehicle being viewed in the AR session.

As further shown in FIG. 5, process 500 may include identifying the one or more nonstandard characteristics that do not correspond to the one or more nonstandard features based on determining whether the one or more nonstandard characteristics correspond to the one or more nonstandard features (block 550). For example, the AR device 210 (e.g., using processor 320 and/or memory 330) may identify the one or more nonstandard characteristics that do not correspond to the one or more nonstandard features based on determining whether the one or more nonstandard characteristics correspond to the one or more nonstandard features, as described above in connection with FIG. 1E. As an example, the AR device may identify the performance tire nonstandard characteristic as a nonstandard characteristic that does not correspond to a nonstandard feature of the vehicle being viewed in the AR session because the vehicle being viewed in the AR session has a standard tire that is a standard feature.

As further shown in FIG. 5, process 500 may include providing an indication of the one or more nonstandard characteristics that do not correspond to the one or more nonstandard features based on identifying the one or more nonstandard characteristics that do not correspond to the one or more nonstandard features (block 560). For example, the AR device 210 (e.g., using processor 320 and/or memory 330) may provide an indication of the one or more nonstandard characteristics that do not correspond to the one or more nonstandard features based on identifying the one or more nonstandard characteristics that do not correspond to the one or more nonstandard features, as described above in connection with FIG. 1H. As an example, a user of a client device may select a Noncorresponding characteristic(s) and Associated Value(s) input option of the GUI, and the AR device may provide, to the user device, data that indicates noncorresponding characteristics associated with a corresponding vehicle and associated values of the noncorresponding characteristics.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1I. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for verifying item-specific data based on data captured by an augmented reality device, the system comprising:
one or more memories; and
one or more processors, communicatively coupled to the one or more memories, configured to:
obtain item-specific data that indicates an expected value associated with an item in a list of items;
receive a set of images captured by the augmented reality device, wherein the set of images are of an object;
detect a set of features included in the set of images, wherein the set of features includes different features of the object;
determine, based on at least one detected feature of the set of features, that the object corresponds to the item in the list of items;
select one or more detected features, of the set of features, based on the expected value associated with the item;
determine, based on the one or more detected features, an actual value associated with the object;
determine whether the actual value associated with the object satisfies a value condition that is based on a difference between the expected value associated with the item and the actual value associated with the object; and
provide an indication of whether the actual value associated with the object satisfies the value condition.

2. The system of claim 1, wherein the item-specific data indicates one or more characteristics associated with the item,
wherein the one or more characteristics are expected to correspond to the one or more detected features, and
wherein the one or more processors are further configured to:
determine whether the one or more characteristics correspond to the one or more detected features;
identify one or more noncorresponding characteristics based on determining that the one or more characteristics do not correspond to the one or more detected features; and
provide an indication of the one or more noncorresponding characteristics.

3. The system of claim 2, wherein the one or more processors are further configured to:
determine a value associated with the one or more noncorresponding characteristics; and
provide an indication of the value associated with the one or more noncorresponding characteristics.

4. The system of claim 1, wherein the one or more processors are further configured to:
determine a difference value based on determining that the actual value associated with the object does not satisfy the value condition; and
provide an indication of the difference value.

5. The system of claim 1, wherein the value condition is that the difference between the actual value associated with the object and the expected value associated with the item satisfies a threshold, and
wherein the one or more processors are further configured to:
identify a subset of the one or more detected features that enable the value condition to be satisfied; and
provide an indication of the subset of the one or more detected features.

6. The system of claim 1, wherein the item-specific data indicates one or more characteristics associated with the item,
wherein the one or more characteristics are expected to correspond to the one or more detected features, and
wherein, to select the one or more detected features, the one or more processors are further configured to:
determine whether the one or more characteristics correspond to the one or more detected features;
identify one or more noncorresponding characteristics based on determining that the one or more characteristics do not correspond to the one or more detected features;
determine whether the one or more noncorresponding characteristics includes at least one nonstandard noncorresponding characteristic;
determine, based on determining that the one or more noncorresponding characteristics includes the at least one nonstandard noncorresponding characteristic, at least one nonstandard value associated with the at least one nonstandard noncorresponding characteristic; and
select the one or more detected features, of the set of features, based on the expected value associated with the item and the at least one nonstandard value associated with the at least one nonstandard noncorresponding characteristic.

7. The system of claim 1, wherein, to determine that the object corresponds to the item, the one or more processors are further configured to:
determine one or more visual characteristics that correspond to the at least one detected feature;
perform a search using an image repository and based on the one or more visual characteristics to identify one or more aspects associated with the item;
determine that the one or more aspects correspond to the at least one detected feature based on the one or more aspects including features having visual characteristics that have a threshold degree of similarity with the one or more visual characteristics; and
determine that the object corresponds to the item based on determining that the one or more aspects correspond to the at least one detected feature.

8. A method of verifying item-specific data based on data captured by an augmented reality device, comprising:
receiving, by a system and from the augmented reality device, a set of images captured during an augmented reality session of the augmented reality device;
detecting, by the system, a plurality of features included in the set of images, wherein the plurality of features includes different features of an object;
identifying, by the system, an item, from a list of items, that corresponds to the object based on at least one feature of the plurality of features,
wherein the list of items identifies one or more characteristics that are expected to correspond to the plurality of features;
determining, by the system, whether the one or more characteristics correspond to the plurality of features;
identifying, by the system, one or more noncorresponding characteristics of the item based on determining that the one or more characteristics do not correspond to the plurality of features;
determining, by the system, a noncorresponding value associated with the one or more noncorresponding characteristics; and
providing, by the system, an indication of the noncorresponding value associated with the one or more noncorresponding characteristics.

9. The method of claim 8, wherein the object is associated with an initial value; and
the method further comprises:
adjusting the initial value based on the noncorresponding value to generate an adjusted value; and
providing an indication of the adjusted value.

10. The method of claim 8, further comprising:
determining an itemized value for at least one noncorresponding characteristic of the one or more noncorresponding characteristics; and
providing an indication of the itemized value for the at least one noncorresponding characteristic.

11. The method of claim 8, wherein the one or more noncorresponding characteristics includes multiple noncorresponding characteristics,
wherein the multiple noncorresponding characteristics are associated with priority levels, and
wherein the method further comprises:
ranking the multiple noncorresponding characteristics, based on the associated priority levels, to generate ranked noncorresponding characteristics; and
providing an indication of the ranked noncorresponding characteristics.

12. The method of claim 8, further comprising:
determining whether the noncorresponding value associated with the one or more noncorresponding characteristics satisfies a threshold;
generating an alert based on the noncorresponding value associated with the one or more noncorresponding characteristics satisfying the threshold; and
providing an indication of the alert.

13. The method of claim 8, further comprising:
updating the list of items to generate an updated list of items such that the updated list of items does not include at least a portion of the one or more noncorresponding characteristics; and
providing the updated list.

14. The method of claim 8, further comprising:
determining a visual characteristic corresponding to an aspect included in at least a portion of the one or more noncorresponding characteristics; and
providing, to the augmented reality device, information that identifies the visual characteristic to cause the augmented reality device to display the information that identifies the visual characteristic for display via a user interface of the augmented reality device.

15. The method of claim 14, further comprising:
obtaining user input provided via the user interface of the augmented reality device, wherein the user input indicates a confirmation or a nonconfirmation that the visual characteristic corresponds to a visual characteristic associated with one or more features of the plurality of features.

16. The method of claim 8, wherein the object is associated with an initial value; and
the method further comprises:
obtaining location information that identifies a location of the augmented reality device; and
adjusting the initial value based on obtaining the location information that identifies the location of the augmented reality device.

17. A non-transitory computer-readable medium storing a set of instructions, the set of instructions comprising:
one or more instructions that, when executed by one or more processors of an augmented reality device, cause the augmented reality device to:
capture a set of images during an augmented reality session;
determine a plurality of features included in the set of images, wherein the plurality of features includes different features of an object including an identifier feature, one or more standard features, and one or more nonstandard features;
decode the identifier feature to identify an item, from a list of items, that corresponds to the object,
wherein the item is associated with one or more nonstandard characteristics that are expected to correspond to the one or more nonstandard features;
determine whether the one or more nonstandard characteristics correspond to the one or more nonstandard features;
identify the one or more nonstandard characteristics that do not correspond to the one or more nonstandard features based on determining whether the one or more nonstandard characteristics correspond to the one or more nonstandard features; and
provide an indication of the one or more nonstandard characteristics that do not correspond to the one or more nonstandard features based on identifying the one or more nonstandard characteristics that do not correspond to the one or more nonstandard features.

18. The non-transitory computer-readable medium of claim 17, wherein the indication of the one or more nonstandard characteristics that do not correspond to the one or more nonstandard features is provided to a device,
wherein the object includes the one or more standard features, and
wherein the one or more instructions, when executed by the one or more processors, further cause the augmented reality device to:
provide, to the device, data associated with the one or more standard features;
obtain, from the device, an estimated value associated with the object based on the one or more standard features and the indication of the one or more nonstandard characteristics that do not correspond to the one or more nonstandard features; and
provide an indication of the estimated value.

19. The non-transitory computer-readable medium of claim 18, wherein an indication of the estimated value is provided to the device,
wherein the item is associated with an expected value, and
wherein the one or more instructions, when executed by the one or more processors, further cause the augmented reality device to:
provide, to the device, data associated with the expected value; and
obtain, from the device, an actual value associated with the object that is based on a difference between the estimated value and the expected value; and
provide an indication of the actual value.

20. The non-transitory computer-readable medium of claim 17, wherein the one or more instructions, when executed by the one or more processors, cause the augmented reality device to:
provide, to a device, data associated with the one or more nonstandard characteristics;
obtain, from the device, an itemized value for at least one nonstandard characteristic of the one or more nonstandard characteristics; and
provide an indication of the itemized value for the at least one nonstandard characteristic.
